(19) United States
(12) Patent Application Publication
(10) Pub. No.: US 2010/0061030 A1
(43) Pub. Date: Mar. 11, 2010

(54) ANTI-SHOCK DEVICE

(76) Inventor: Norman Werbner, Long Key, FL (US)

Correspondence Address: HOVEY WILLIAMS LLP, 10801 Mastin Blvd., Suite 1000, Overland Park, KS, 66210, US

(21) Appl. No.: 12/207,236

(22) Filed: Sep. 9, 2008

(51) Int. Cl. H05F 3/02

(52) U.S. Cl. 361/212

(57) ABSTRACT

An anti-shock device that generally comprises one or more thin wires that can optionally be embedded in a substantially flat insulating body. The device can be directly or indirectly connected to a conductive object and/or an electric ground. When a subject contacts the device prior to contacting a conductive object, the pain and/or discomfort associated with an electrostatic shock can be greatly reduced or eliminated.

### BACKGROUND

1. Field of the Invention

This invention relates to processes and devices for controlling the discharge of static electricity. In another aspect, the invention concerns an anti-shock device capable of reducing or eliminating the pain and discomfort associated with electrostatic shock.

2. Description of the Related Art

During the course of a person's daily activities, one often builds and stores an electrostatic charge. When the person comes into contact with a conductive object having a different electrostatic potential, such as a doorknob or a car door handle, a burst of electricity passes between the person and the conductive object, thereby causing the person to experience an electrostatic shock. Certain activities (e.g., walking on carpet or handling synthetic fabrics) and environments (e.g., low humidity) aggravate the charge imbalance and result in more frequent and/or more powerful shocks. While not usually harmful to the person, electrostatic shocks are uncomfortable, even painful, and can be difficult to avoid.

### SUMMARY

In one embodiment of the present invention, there is provided a process for reducing or eliminating discomfort associated with electrostatic shock. The process comprises contacting a non-insulated portion of a subject's body with a touch surface of an anti-shock device, wherein the anti-shock device comprises a plurality of thin wires. Each of the thin wires has a diameter of less than 0.035 inches and includes a connected end and an exposed end. The connected ends are electrically connected to a conductive object and/or to an electric ground and the exposed ends define at least a portion of the touch surface. The contacting of the subject's body with the touch surface causes static electricity to pass between the subject and the conductive object and/or the electric ground through at least one of the thin wires.

In another embodiment of the present invention, there is provided an anti-shock device for reducing or eliminating discomfort associated with electrostatic shock between a subject and a conductive object and/or an electric ground. The anti-shock device comprises a substantially flat insulating body and one or more thin wires embedded in the insulating body. The insulating body defines a front surface and a rear surface, with the front and rear surfaces being substantially co-planar. The thin wires extend through the insulating body substantially between the front and rear surfaces. Each of the thin wires has a diameter of less than 0.035 inches. Each of the thin wires includes a connected end and an exposed end. The exposed ends of the thin wires are located at or near the front surface and are configured to receive static electricity passed between the subject and the conductive object and/or the electric ground when the subject makes contact with one or more of the exposed ends of the thin wires.

In yet another embodiment of the present invention, there is provided an anti-shock device for reducing or eliminating discomfort associated with electrostatic shock between a subject and a conductive object and/or an electric ground. The anti-shock device comprises a substantially flat insulating body, a plurality of laterally spaced, exposed cross-sections, and a conductive backplate. The insulating body defines a front surface and a rear surface that are substantially coplanar. The cross-sections are located at or near the front surface of the insulating body and comprise an electrically conductive material. The surface area of each exposed cross-section is less than 9.75×10⁻⁴ square inches. The conductive backplate is physically coupled to the rear surface of the insulating body. The exposed cross-sections are configured to receive static electricity passed between the subject and the conductive object and/or the electric ground when the subject makes contact with one or more of the cross-sections.

### BRIEF DESCRIPTION OF THE FIGURES

Certain embodiments of the present invention are described in detail below with reference to the enclosed figures, in which like reference numerals are used to indicate like parts in the various views, wherein:

FIG. 1 is a schematic break-away view of an anti-shock device configured according to one embodiment of the present invention;

FIG. 2a is a schematic diagram illustrating one embodiment of a potential electrical configuration for an anti-shock device configured according to one or more embodiments of the present invention;

FIG. 2b is a schematic diagram illustrating another embodiment of a potential electrical configuration for an anti-shock device configured according to one or more embodiments of the present invention;

FIG. 2c is a schematic diagram illustrating yet another embodiment of a potential electrical configuration for an anti-shock device configured according to one or more embodiments of the present invention;

FIG. 3 is a schematic diagram of an anti-shock device configured according to one embodiment of the present invention, wherein the anti-shock device is used in combination with a doorknob;

FIG. 4a is a schematic diagrams of an anti-shock device configured according to one embodiment of the present invention, wherein the anti-shock device is used in combination with a handle;

FIG. 4b is a schematic diagram particularly illustrating a method of using the anti-shock device illustrated in FIG. 4a according to one embodiment of the present invention;

FIG. 5 is a schematic diagram of an anti-shock device configured according to one embodiment of the present invention, wherein the anti-shock device is used in combination with an automobile door;

FIG. 6 is a schematic diagram of an anti-shock device configured according to one embodiment of the present invention, wherein the anti-shock device is in the form of a knob;

FIG. 7 is a schematic diagram of an anti-shock device configured according to one embodiment of the present invention, wherein the anti-shock device is used in combination with a computing device;

FIG. 8 is a schematic diagram of an anti-shock device configured according to one embodiment of the present invention, wherein the anti-shock device is in the form of a mat; and

FIG. 9 is a schematic diagram of an anti-shock device configured according to one embodiment of the present invention wherein the anti-shock device is used by a domesticated animal in the form of a touch pad and/or a floor mat.

### DETAILED DESCRIPTION

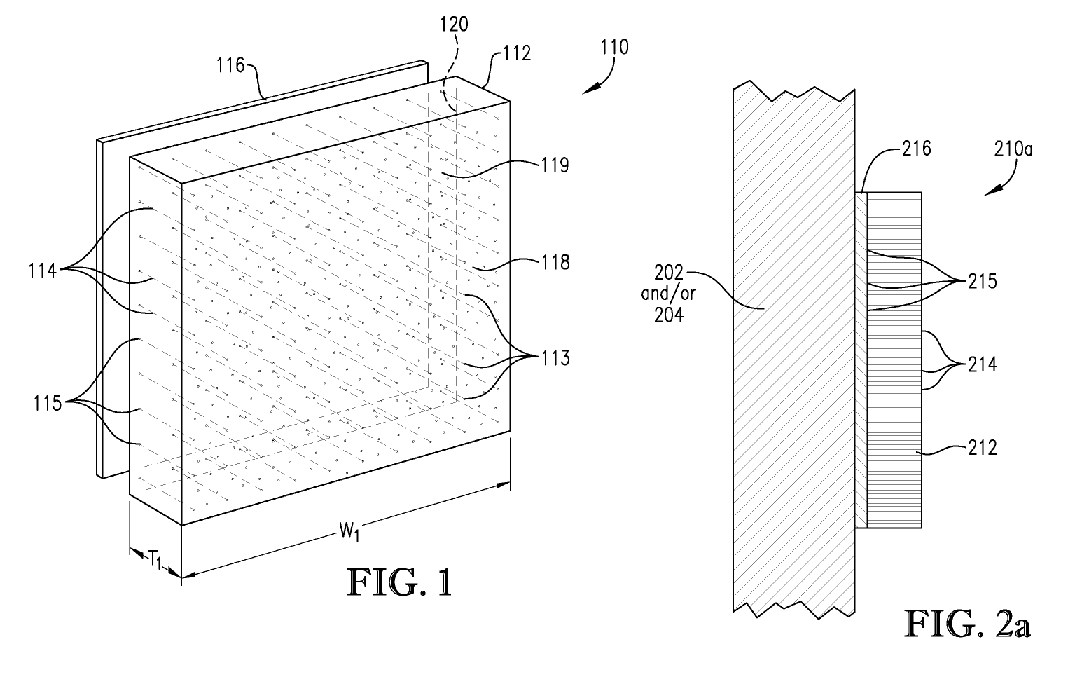

An anti-shock device capable of reducing or eliminating the pain and discomfort associated with an electrostatic shock that occurs between a subject and a conductive (i.e., shock-generating) object has been discovered. When a subject touches a conductive object having a different electrostatic potential, it has been found that the pain and/or discomfort associated with the related electrostatic shock are greatly reduced or even eliminated by utilizing an anti-shock device according to one or more embodiments of the present invention. In general, the anti-shock device can be constructed in a wide variety of shapes and sizes, and can be effectively employed in a number of situations. Several exemplary embodiments of anti-shock devices, and methods of using the same, are discussed in detail below with reference to FIGS. 1-9.

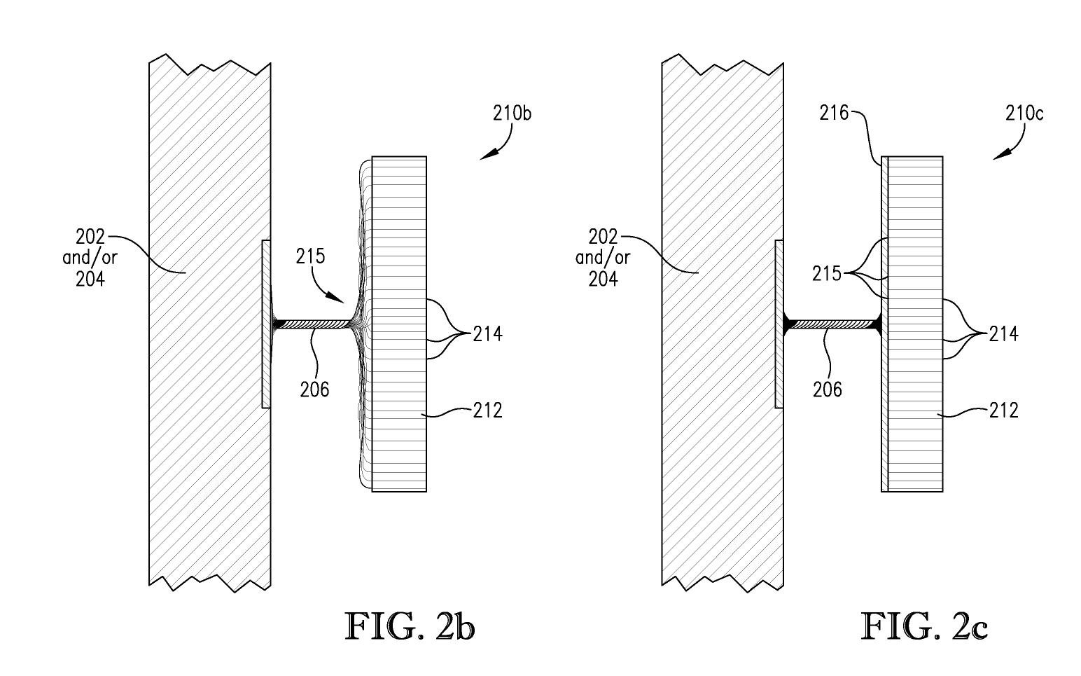

Referring first to FIG. 1, one embodiment of anti-shock device 110 is illustrated. In one embodiment illustrated in FIG. 1, anti-shock device 110 can comprise one or more substantially continuous, thin wires 114 optionally embedded in an insulating body 112. Each of thin wires 114 defines an exposed end 113 and a connected end 115. In general, exposed ends 113 of thin wires 114 define at least a portion of a touch surface 118. Touch surface 118 can be configured to receive static electricity passed between a subject and a conductive object and/or an electric ground when the subject makes contact with one or more exposed ends 113 of touch surface 118. In one embodiment, exposed ends 113 can be located at or near a front surface 119 of insulating body 112 such that insulating body 112 can cooperatively define at least a portion of touch surface 118, as illustrated in FIG. 1. In another embodiment, exposed ends 113 can protrude from insulating body 112 such that touch surface 118 is substantially defined by exposed ends 113 of thin wires 114. In a further embodiment, insulating body 112 can be absent from anti-shock device 110 and touch surface 118 can be substantially defined by exposed ends 113 of thin wires 114. Connected ends 115 and an optional conductive backplate 116 can generally be configured to transport at least a portion of the static electricity between exposed ends 113 and a conductive object and/or an electric ground (not shown in FIG. 1). Several examples of specific electrical and physical configurations of anti-shock device 110 will be described in detail shortly, with respect to FIGS. 2a-c.

Insulating body 112, when present, can be constructed of any suitable, substantially non-conductive material. In one embodiment, insulating body 112 can have a resistivity greater than about 10¹⁰, greater than about 10¹⁵, greater than about 10²⁰ ohm-meters (ohm-m) at 20° C. Examples of materials suitable for use in insulating body 112 can include, but are not limited to, glass, wood, and plastics, such as polyvinyl chloride (PVC) and high or low density polyethylene (HDPE or LDPE). In addition, depending, in part, on the specific application, insulating body 112 can be substantially flexible, semi-flexible, substantially rigid, or semi-rigid.

In general, insulating body 112 can be any shape and/or size. In one embodiment, illustrated in FIG. 1, insulating body 112 can be substantially flat such that front and rear surfaces 119 and 120 are substantially co-planar or substantially parallel. Regardless of its specific shape, insulating body 112 can have a maximum width (W₁) and a maximum thickness (T₁). In one embodiment, the ratio of the maximum thickness to the maximum width of the insulating body can be in the range of from about 0.005:1 to about 1:1, about 0.01:1 to about 0.75:1, or 0.05:1 to 0.5:1. Although the specific dimensions of anti-shock device depend, in part, on the specific application in which the device is employed, the maximum thickness of insulating body 112 can be less than about 1.5 inches, less than about 1 inch, less than about 0.5 inches, less than about 0.4 inches, less than about 0.25 inches, less than about 0.15 inches, less than about 0.10 inches, less than about 0.05 inches, or less than 0.01 inches. In another embodiment, the maximum width of insulating body 112 can be in the range of from about 0.05 to about 36 inches, about 0.5 to about 24 inches, about 1 to about 12 inches, or 2 to 5 inches.

According to one embodiment, anti-shock device 110 can comprise one or more thin wires 114. In another embodiment, insulating body 112 comprises a plurality of thin wires 114 embedded in and extending through insulating body 112. As used herein, the term “wire” refers to a single elongated, conductive element and is not necessarily limited to conventional types of wire. Wires suitable for use in several embodiments of the present invention can be manufactured using a variety of methods, such as, for example, drawing, molding, or casting. In one embodiment, thin wires 114 can be formed prior to insertion into insulating body 112 and/or coupling with conductive backplate 116, while in another embodiment, thin wires 114 can be formed with or within insulating body 112 and/or conductive backplate 116. Thin wires 114 can be made of any suitable electrically conductive material. In one embodiment, thin wires 114 can have a resistivity of less than about 10⁻⁵, less than about 10⁻⁶, less than about 10⁻⁷, or less than 10⁻⁸ ohm-m at 20° C. Examples of materials suitable for use in thin wires 114 can include, but are not limited to, copper, aluminum, gold, silver, tungsten, iron, platinum, and alloys thereof.

In one embodiment, each of exposed ends of thin wires 114 can have a diameter in the range of from about 10⁻¹⁰ inches to about 0.035 inches, about 10⁻⁸ to about 0.030 inches, or 10⁻⁶ to 0.025 inches. As used herein, the term “diameter” refers a straight line passing from one side of a figure or body to another that passes through the center or centroid of the figure or body. The term “diameter” does not necessarily limit thin wires 114 to a substantially circular cross-section. In one embodiment, the surface area of exposed ends 113 can be less than about 9.75×10⁻⁴, less than about 7.25×10⁻⁴, or less than 5×10⁻⁴ square inches. According to one embodiment, exposed ends 113 of thin wires 114 can have a substantially circular cross-section. In another embodiment, thin wires 114 can have a gauge of 16 or higher, 18 or higher, 20 or higher, 22 or higher, or 24 or higher, based on the American Wire Gauge (AWG) standard. In one embodiment, the length of thin wires 114 can be similar to the thickness of insulating body 112, while, in another embodiment, thin wires 114 can have a length substantially different from the thickness of insulating body 112. According to one embodiment, thin wires 114 can have a length of less than about 10 inches, less than about 6 inches, less than about 4 inches, less than about 2 inches, less than about 1 inch, less than about 0.75 inches, less than about 0.5 inches, or less than 0.3 inches.

As shown in one embodiment depicted in FIG. 1, the plurality of single, thin wires 114 embedded in insulating body 112 can be laterally spaced from one another and embedded in insulating body 112. When thin wires 114 are embedded in insulating body 112, the wires can be arranged in any suitable pattern. In one embodiment, thin wires 114 can be embedded in a direction substantially normal to front and rear surfaces 118 and 120. In another embodiment, thin wires 114 can be embedded in insulating body 112 in an angular direction from front and/or rear surfaces 119, 120. In one embodiment, anti-shock device 110 can have an overall wire density in the range of from about 0.5 to about 100 wires per square inch, about 1 to about 60 wires per square inch, or 2 to 30 wires per square inch, wherein overall wire density is defined as the ratio of number of wires per surface area (in square inches) of the touch surface 118 and/or front surface 119 of insulating body 112.

According to one embodiment, anti-shock device 110 can optionally comprise a conductive backplate 116 optionally physically attached to insulating body 112 and electrically coupled to connected ends 115. In general, conductive backplate 116 can be made of any suitable conductive material, including, for example, those previously described with respect to thin wires 114. In one embodiment, conductive backplate 116 can have a resistivity of less than about 10⁻⁵, less than about 10⁻⁶, less than about 10⁻⁷, or less than 10⁻⁸ ohm-m at 20° C. In one embodiment, conductive backplate 116 can be electrically connected to at least a portion of the connected ends 115 of thin wires 114 and, in the same or other embodiments, can also be in electrical connection with one or more transport wires (not shown in FIG. 1).

In direct contrast to conventional shock-reduction devices, anti-shock device 110 does not necessarily employ resistance elements to slow the rate of static electricity passed between the subject and anti-shock device 110. In one embodiment, the total electrical resistance between exposed ends 113 of thin wires 114 and the conductive object and/or electric ground can be less than about 5,000 ohms, less than about 1,000 ohms, less than about 500 ohms, less than about 250 ohms, or less than 100 ohms. On the contrary, most conventional shock-reduction devices employing resistance elements have a total electrical resistance in excess of 1 mega-ohm (1 million ohms). Several embodiments of electrical connections contemplated for anti-shock device 110 will now be described in detail with reference to FIGS. 2a-c.

Referring first to FIG. 2a, an anti-shock device 210a configured according to one embodiment of the present invention is illustrated. Anti-shock device 210a can include a conductive backplate 216, which can be physically coupled to insulating body 212 and electrically coupled to connected ends 215 of thin wires 214. In one embodiment, anti-shock device 210a can be directly coupled to conductive object 202 and/or electric ground 204 via one or more fasteners (not shown). Examples of suitable fasteners can include, but are not limited to, adhesives, screws, bolts, double-sided tapes, and the like.

Turning to FIGS. 2b and 2c, anti-shock devices 210b and 210c are illustrated. According to the embodiments depicted in FIGS. 2b and 2c, connected ends 215 of thin wires 214 can be electrically connected to conductive object 202 and/or an electric ground 204 via one or more transport wires 206. When present, as shown in FIG. 2c, conductive backplate 216 provides an electrical connection between thin wires 214 and conductive object 202 and/or electric ground 204 via transport wire 206. The specific electrical and/or physical configurations of anti-shock devices according to one or more embodiments of the present invention can depend, in part, on the desired end-use of the anti-shock device.

In one embodiment of the present invention, there is provided a process for reducing or eliminating the pain and discomfort associated with static shock that includes the step of contacting an anti-shock device with a non-insulated portion of a subject's body. Although the static electricity may still pass between the subject and the conductive object and/or an electric ground, the anti-shock device is capable of drastically reducing, or even eliminating, the pain and discomfort associated with the resulting static shock.

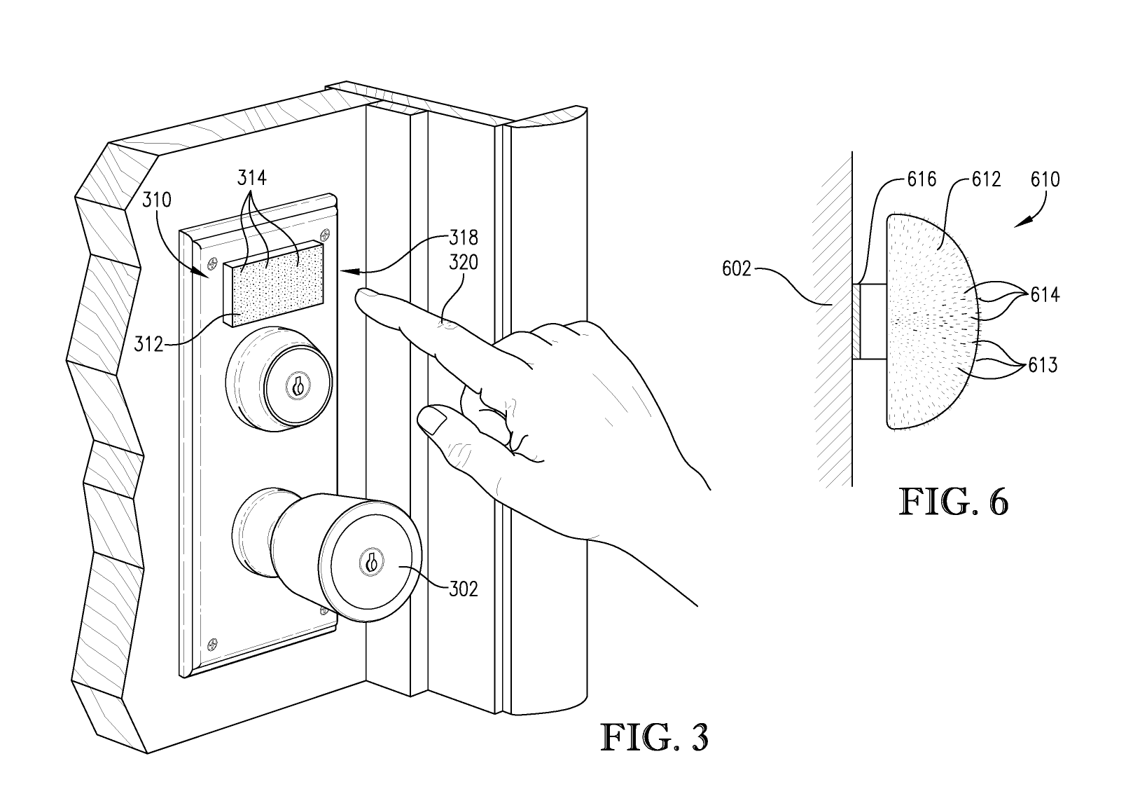

Referring now to FIG. 3, one embodiment of an anti-shock device 310 is illustrated as being electrically coupled with a doorknob 302. To reduce the pain and discomfort of an electrostatic shock associated with contacting doorknob 302, a subject can first contact touchpad 318 with a non-insulated portion of the subject's body (e.g., a finger 320). Upon contact with touchpad 318, the subject's finger also touches at least a portion of thin wires 314. Although not wishing to be bound by theory, it has been hypothesized that thin wires 314 facilitate the relatively painless dissipation of at least part of the static charge accumulated and stored by the subject. As the accumulated charge is dissipated from the subject, the electric potential of the subject and the conductive object substantially equalize, thereby allowing the subject to subsequently contact doorknob 302 without receiving a painful or uncomfortable static shock.

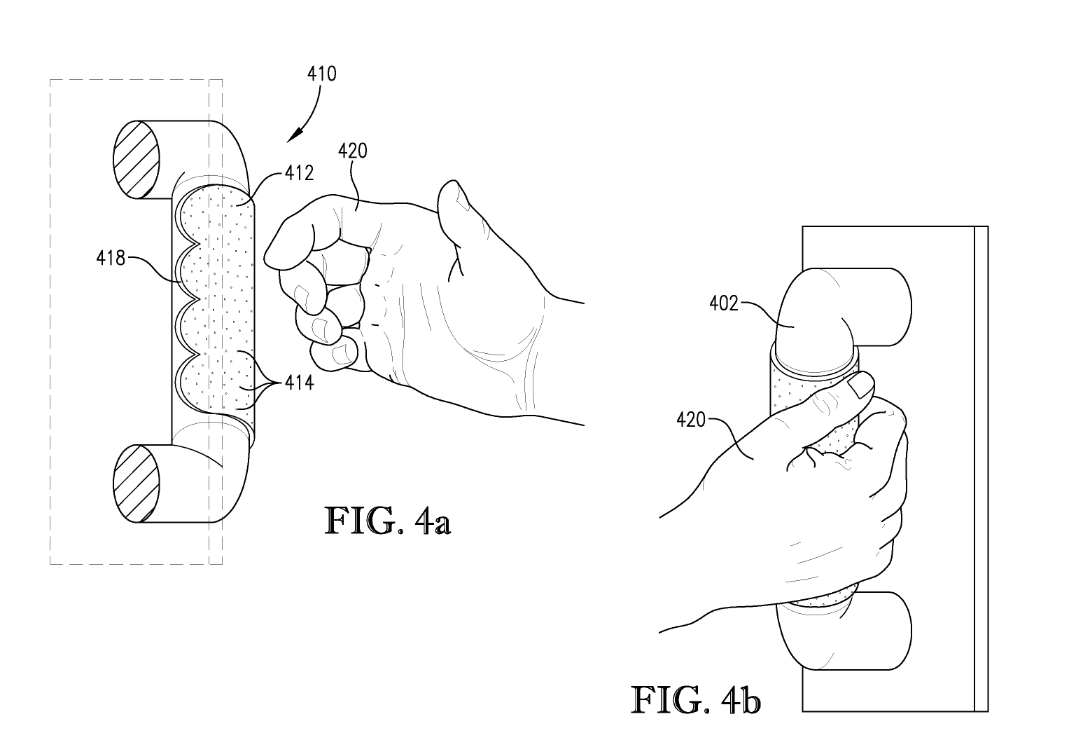

In another embodiment of the present invention, illustrated in FIGS. 4a and 4b, the anti-shock device 410 can be at least partially integrated into the conductive object (e.g., filing cabinet handle 402) from which the subject desires shock protection. As illustrated in FIG. 4a, insulating body 412 and thin wires 414 of anti-shock device 410 can be configured to form a contoured touch surface 418. As shown in FIG. 4b, when anti-shock device 410 is integrated with handle 402 or other conductive object, the subject's hand 420 or other non-insulated body part can contact anti-shock device 410 and handle 402 simultaneously.

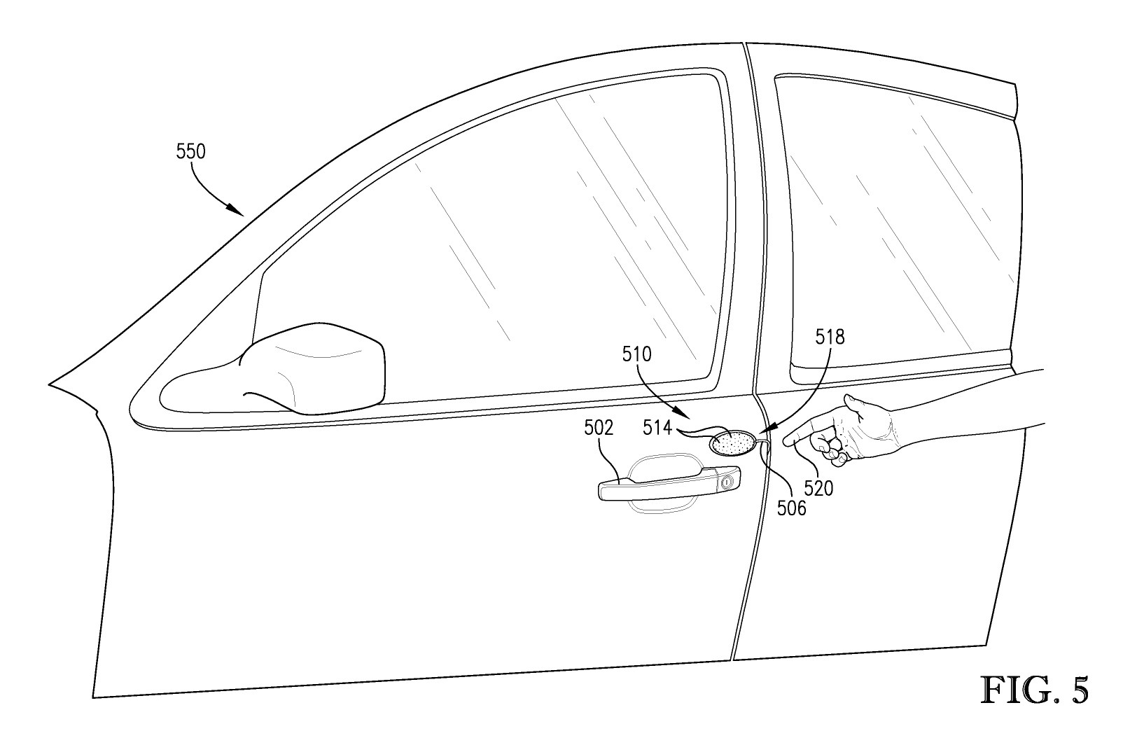

Turning now to FIG. 5, one embodiment of an anti-shock device 510 connected to an automobile 550 is illustrated. As illustrated in FIG. 5, anti-shock device 510, which can have a substantially circular cross-section, comprises a plurality of thin wires 514 and a transport wire 506 electrically connecting a conductive backplate (not shown in FIG. 5) to any conductive point on automobile 550. To reduce the adverse effects of an electrostatic shock, the subject can first contact finger 520 with touch surface 518 prior to touching handle 502. Anti-shock device 510 can be physically coupled to any point of automobile 550 according to any known attaching mechanism. In one embodiment, anti-shock device can be magnetically coupled to automobile door 550.

According to another embodiment, illustrated in FIG. 6, anti-shock device 610 can include a substantially contoured insulating body 612 having a plurality of thin wires 614 protruding therefrom. In one embodiment, prior to contacting a conductive object 602, a subject can grip anti-shock device 610, thereby contacting at least a portion of exposed ends 613 of thin wires 614 to dissipate at least a portion of the subject's accumulated charge. In another embodiment illustrated in FIG. 6, anti-shock device 610 can be directly (via back plate 616 as shown in FIG. 6) or indirectly (via one or more transport wires, not shown in FIG. 6) connected to conductive device 602 and/or an electric ground (not shown). In addition to the substantially rounded profile illustrated in FIG. 6, anti-shock device 610 can have a variety of practical and/or aesthetic configurations depending, in part, on the specific application in which the device is employed.

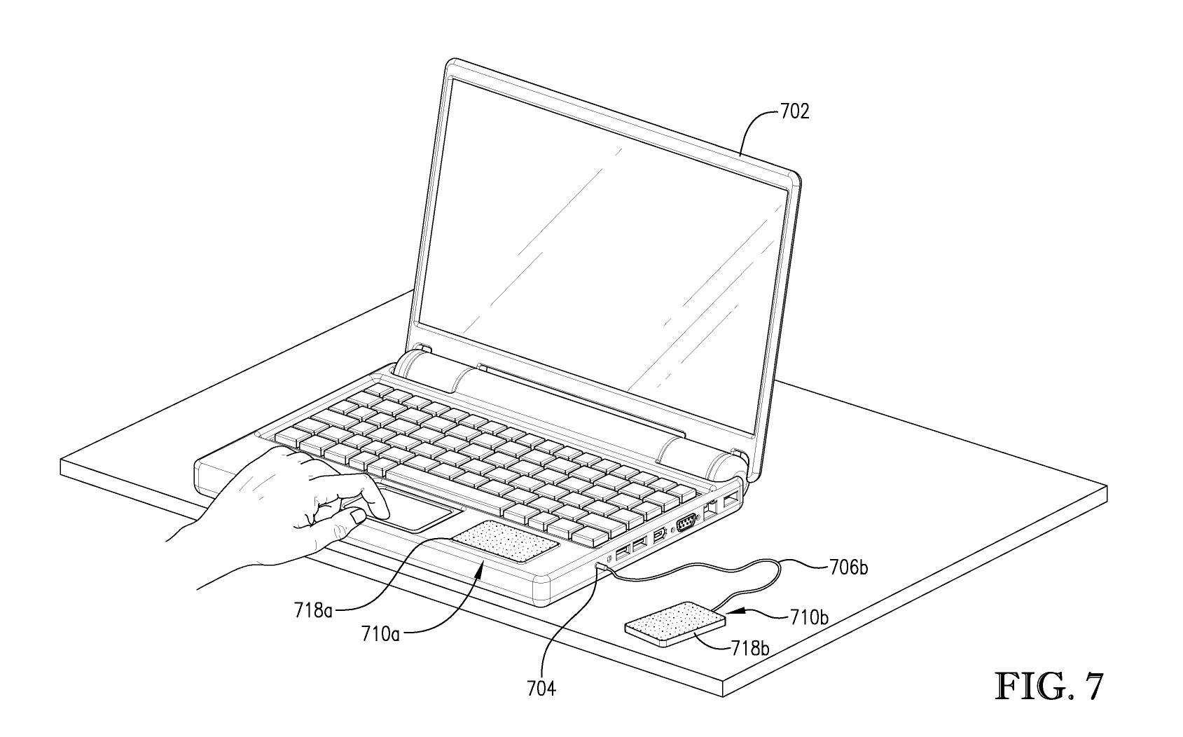

In one embodiment of the present invention, the anti-shock device can be at least partially integrated into the conductive object from which the subject desires shock protection. Referring now to FIG. 7, anti-shock device 710a, configured according to one embodiment of the present invention, is illustrated as being integrated with a surface of a laptop computer 702. According to another embodiment illustrated in FIG. 7, another anti-shock device 710b can be connected to laptop 702 via a transport wire 706b. As shown in FIG. 7, anti-shock devices 710a and 710b each includes a respective touch surface 718a and 718b. Touch surface 718a can be substantially continuous with one or more surfaces of laptop 702. In one embodiment, at least a portion of any static electricity passed between the subject and anti-shock device 710b can be passed via transport wire 706b to an electric ground 704. In one embodiment illustrated in FIG. 7, electric ground 704 can also be integrated with the conductive object (e.g., laptop 702). In another embodiment (not shown) electric ground 704 can be independent of (e.g., physically separate from) laptop 702. In one embodiment wherein anti-shock device 710 is integrated with the conductive object (e.g., laptop 702), the anti-shock device can be incorporated during production by the manufacturer, rather than retrofitted to the commercial device by the end-user.

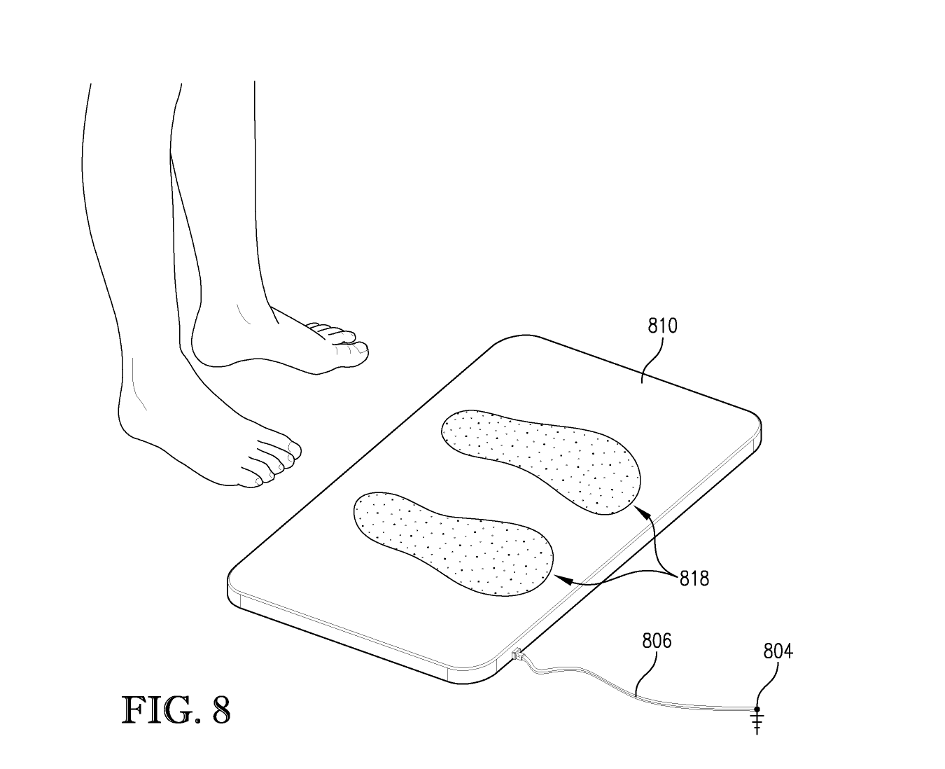

In addition to hands and fingers, as discussed previously, the subject can contact anti-shock device 810 with other non-insulated body parts, including, for example, the subject's elbow, arm, leg, knee, head, nose, back, or wrist. In another embodiment, shown in FIG. 8, the subject can contact touch surface 818 of anti-shock device 810 with the subject's toes, feet, and/or heels. As illustrated in FIG. 8, anti-shock device 810 can also be in the form of a mat or pad and touch surface 818 can be in any shape or configuration. In one embodiment, anti-shock device 810 can be indirectly connected to electric ground 804 via transport wire 806, as illustrated in FIG. 8.

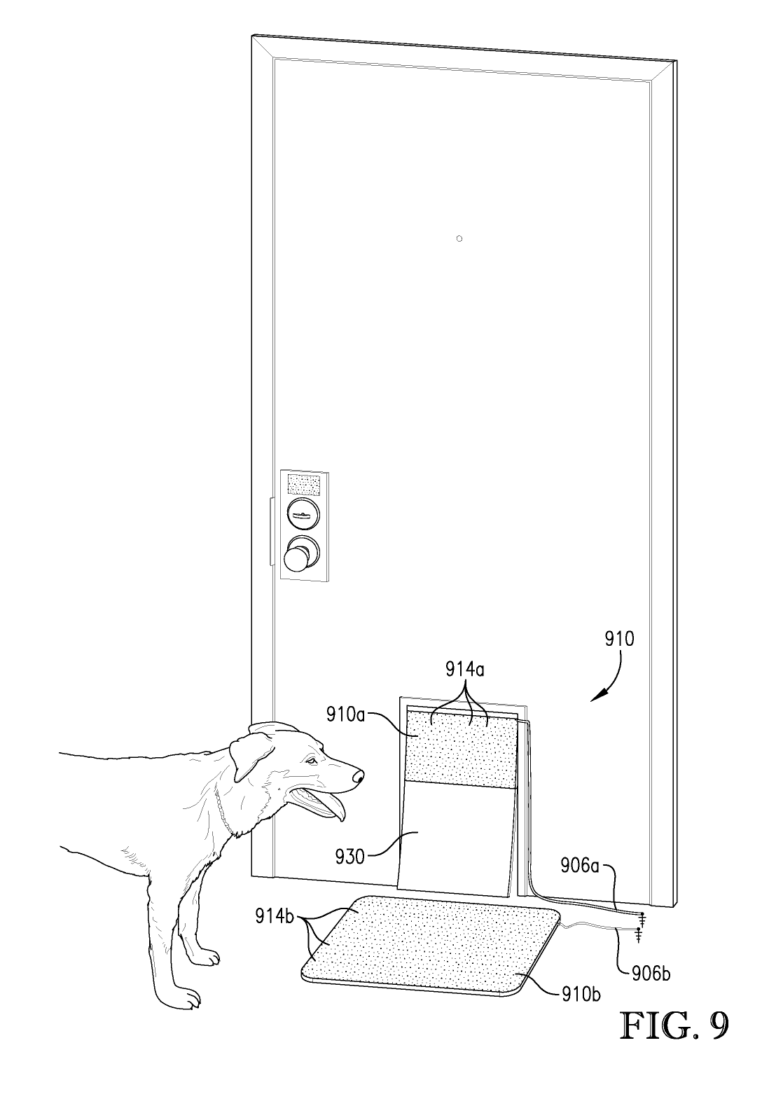

In one embodiment, the subject can be a household pet or other domesticated animal, such as, for example, a dog or a cat. One embodiment of an anti-shock system 910 suitable for use by non-human subjects is illustrated in FIG. 9. As shown in FIG. 9, anti-shock system 910 can include two or more anti-shock devices 910a and 910b. In one embodiment, one anti-shock device 910a can be positioned on a door (e.g., a pet door) 930. In another embodiment, anti-shock device 910b can be positioned on the floor proximate pet door 930. As the animal (e.g., dog) passes through the door, its paws contact anti-shock mat 910b and/or its nose can contact anti-shock device 910a to thereby reduce a portion of the animal's accumulated charge. In addition to reducing the level of pain experienced by the animal due to static shock, anti-shock system 910 can also reduce the adverse effects of electrostatic shock experienced by both parties when the human and non-human subjects touch.

The anti-shock devices configured according to one or more embodiments the present invention can be successfully implemented in a wide variety of household, industrial, automotive, electronic, medical, and other applications to reduce the pain and discomfort associated with electrostatic shocks according to one or more methods described previously. Although several different physical configurations and applications were discussed previously, it should be understood that elements from one or more embodiments described above may be combined with one or more other elements from other embodiments described above without departing from the spirit of the present invention.

In addition to the embodiments described above, several other commercially useful embodiments have also been contemplated. For example, in one embodiment, the anti-shock device can be in the form of a sheet, purchased by a user and then adjusted (via cutting or other suitable method) to fit one or more specific applications. In another embodiment, the anti-shock device can be configured as described above, except, rather than include thin wires, the anti-shock device could comprise an insulating body having a plurality of small diameter holes and a conductive backplate.

### Numerical Ranges

The present description uses numerical ranges to quantify certain parameters relating to the invention. It should be understood that when numerical ranges are provided, such ranges are to be construed as providing literal support for claim limitations that only recite the lower value of the range as well as claims limitation that only recite the upper value of the range. For example, a disclosed numerical range of 10 to 100 provides literal support for a claim reciting “greater than 10” (with no upper bounds) and a claim reciting “less than 100” (with no lower bounds).

### DEFINITIONS

As used herein, the terms “a,” “an,” “the,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “containing,” “contains,” and “contain” have the same open-ended meaning as “comprising,” “comprises,” and “comprise” provided above.

As used herein, the terms “having,” “has,” and “have” have the same open-ended meaning as “comprising,” “comprises,” and “comprise” provided above.

As used herein, the terms, “including,” “include,” and “included” have the same open-ended meaning as “comprising,” “comprises,” and “comprise” provided above.

As used herein, the term “overall wire density” refers to the number of wires per surface area of the insulator, generally measured in wires per square inch.

As used herein, the term “wire” refers to any elongated, conductive element.

### Claims Not Limited to the Disclosed Embodiments

The preferred forms of the invention described above are to be used as illustration only, and should not be used in a limiting sense to interpret the scope of the present invention. Modifications to the exemplary embodiments, set forth above, could be readily made by those skilled in the art without departing from the spirit of the present invention.

The inventor hereby states his intent to rely on the Doctrine of Equivalents to determine and assess the reasonably fair scope of the present invention as pertains to any apparatus not materially departing from but outside the literal scope of the invention as set forth in the following claims.

What is claimed is:

1. A process for reducing or eliminating discomfort associated with electrostatic shock, said process comprising: contacting a non-insulated portion of a subject's body with a touch surface of an anti-shock device, wherein said anti-shock device comprises a plurality of thin wires, wherein each of said thin wires has a diameter of less than about 0.035 inches, wherein each of said thin wires includes a connected end and an exposed end, wherein each of said connected ends are electrically connected to a conductive object and/or to an electric ground, wherein said exposed ends of said thin wires define at least a portion of said touch surface, wherein said contacting of said subject's body with said touch surface causes static electricity to pass between said subject and said conductive object and/or said electric ground through at least one of said thin wires.

2. The process of claim 1, wherein said thin wires are embedded in an insulating body defining a front surface and a rear surface.

3. The process of claim 2, wherein said anti-shock device optionally comprises a conductive backplate physically coupled to said insulating body, wherein said conductive back plate provides an electrical connection between said thin wires and said conductive object and/or said electric ground.

4. The process of claim 3, wherein said anti-shock device comprises one or more transport wires electrically connected to said connected ends of said thin wires and/or electrically connected to said conductive backplate if said backplate is present.

5. The process of claim 4, further comprising passing at least a portion of said static electricity to said conductive object and/or said electrical ground using said one or more transport wires.

6. The process of claim 2, wherein said anti-shock device is physically coupled to said conductive object, wherein said connected ends of said thin wires are electrically connected to said conductive object.

7. The process of claim 6, wherein said anti-shock device comprises a conductive back plate physically coupled to said insulating body and electrically connected to said connected ends of said thin wires, wherein said conductive back plate is physically and electrically connected to said conductive object.

8. The process of claim 2, wherein said insulating body is substantially flat and defines a front surface and a rear surface, wherein said front and rear surfaces are substantially co-planar, wherein said touch surface is cooperatively defined by said front surface and said exposed ends of said thin wires.

9. The process of claim 8, wherein said thin wires extend through said insulating body in a direction that is substantially normal to said front and rear surfaces.

10. The process of claim 2, wherein the ratio of the maximum thickness of said insulating body to the maximum width of said insulating body is in the range of from about 0.005:1 to about 1:1.

11. The process of claim 2, wherein the maximum thickness of said insulating body is less than about 1.5 inches, wherein the maximum width of said insulating body is in the range of from about 0.05 to about 36 inches.

12. The process of claim 2, wherein the total electrical resistance between said exposed ends of said thin wires and said conductive object and/or said electric ground is less than 5,000 ohms.

13. The process of claim 2, wherein said insulating body has a resistivity of at least 10¹⁵ ohm-meters (ohm-m) at 20° C., wherein each of said thin wires has a resistivity of less than 10⁻⁵ ohm-m at 20° C.

14. The process of claim 2, wherein said plurality of thin wires comprises a plurality of single wires that are laterally spaced from one another, wherein said anti-shock device has an overall wire density in the range of from about 0.5 to about 100 thin wires per square inch of said front surface of said insulating body.

15. The process of claim 2, wherein said exposed end of each of said wires defines an exposed cross-section that is substantially flush with said front surface of said insulating body.

16. The process of claim 2, wherein said anti-shock device defines a contoured touch surface.

17. The process of claim 2, wherein said touch surface is integrated with one or more surfaces of said conductive object.

18. The process of claim 1, wherein said conductive object is selected from the group consisting of an automobile, a computing device, a handle, a knob, electronic equipment, and a filing cabinet.

19. The process of claim 1, further comprising, subsequent to said contacting of said subject's body with said touch surface, contacting said subject's body with said conductive object.

20. The process of claim 1, wherein said subject is a domesticated animal or household pet.

21. An anti-shock device for reducing or eliminating discomfort associated with electrostatic shock between a subject and a conductive object and/or an electric ground, said anti-shock device comprising:
a substantially flat insulating body defining a front surface and a rear surface, wherein said front and rear surfaces are substantially co-planar; and
one or more thin wires embedded in said insulating body, wherein said one or more thin wires extends through said insulating body substantially between said front and rear surfaces, wherein said one or more thin wires has a diameter less than about 0.035 inches, wherein said one or more thin wires includes a connected end and an exposed end, wherein said exposed ends are located at or near said front surface,
wherein said exposed ends of said one or more thin wires are configured to receive static electricity passed between said subject and said conductive object and/or said electric ground when said subject makes contact with one or more of said exposed ends.

22. The device of claim 21, wherein said anti-shock device optionally comprises a conductive backplate physically coupled to said rear connection surface of said insulating body, wherein said conductive backplate is in electrical connection with said connected ends of said one or more thin wires.

23. The device of claim 22, wherein said anti-shock device further comprises one or more transport wires electrically connected to said connected ends of said one or more thin wires and/or said conductive backplate if said conductive backplate is present, wherein said one or more transport wires are operable to transport at least a portion of said static electricity to said conductive object and/or an electric ground.

24. The device of claim 21, wherein said anti-shock device comprises a conductive back plate physically coupled to said insulating body and electrically connected to said connected ends of one or more said thin wires, wherein said conductive back plate is operable to be directly or indirectly coupled to a conductive object and/or an electric ground.

25. The device of claim 21, wherein the ratio of the maximum thickness of said insulating body to the maximum width of said insulating body is in the range of from about 0.005:1 to about 1:1.

26. The device of claim 21, wherein the total electrical resistance between said exposed ends of said one or more thin wires and said connected end of said one or more thin wires is less than 5,000 ohms.

27. The device of claim 21, wherein said one or more thin wires comprises a plurality of single wires that are laterally spaced from one another, wherein said anti-shock device has an overall wire density in the range of from about 0.5 to about 100 thin wires per square inch of said front surface.

28. The device of claim 21, wherein said exposed end of each of said wires defines an exposed cross-section that is substantially flush with said front surface of said insulating body.

29. The device of claim 21, wherein said exposed ends of said one or more thin wires protrudes outwardly from said front surface of said insulating body.

30. An anti-shock device for reducing or eliminating discomfort associated with electrostatic shock between a subject and a conductive object and/or an electric ground, said anti-shock device comprising:
a substantially flat insulating body defining a front surface and a rear surface, wherein said front and rear surfaces are substantially co-planar;
one or more laterally spaced exposed cross-sections located at or near said front surface of said insulating body, wherein said exposed cross-sections comprise an electrically conductive material, wherein the surface area of each of said exposed cross-sections is less than 9.75×10⁻⁴ square inches; and
a conductive backplate physically coupled to said rear surface of said insulating body,
wherein said exposed cross-sections are configured to receive static electricity passed between said subject and said conductive object and/or said electric ground when said subject makes contact with one or more of said one or more exposed cross-sections.

31. The device of claim 30, further comprising a plurality of thin wires embedded in said insulating body, wherein said thin wires define an exposed end and a connected end, wherein said exposed ends of said thin wires define said exposed cross-sections, wherein said connected ends are electrically coupled to said conductive backplate.

32. The device of claim 31, wherein said anti-shock device further comprises one or more transport wires electrically connected to said connected ends of said thin wires and/or said conductive backplate, if said conductive backplate is present, wherein said one or more transport wires are operable to transport at least a portion of said static electricity to said conductive object and/or an electric ground.

33. The device of claim 30, wherein said conductive backplate is operable to be physically and electrically connected to said conductive object and/or an electric ground.

34. The device of claim 30, wherein the ratio of the maximum thickness of said insulating body to the maximum width of said insulating body is in the range of from about 0.005:1 to about 1:1.

35. The device of claim 34, wherein said maximum thickness of said insulating body is less than about 0.25 inches.
